(19) United States
(12) Patent Application Publication
(10) Pub. No.: US 2021/0361530 A1
(43) Pub. Date: Nov. 25, 2021

(54) APPARATUS FOR OPTICALLY COUNTING DISCRETE OBJECTS

(71) Applicant: Electronic Engineering LLC, Matawan, NJ (US)

(72) Inventors: Samuel Dworkin, Matawan, NJ (US); Emily Dworkin, Matawan, NJ (US)

(21) Appl. No.: 16/880,816

(22) Filed: May 21, 2020

(51) Int. Cl. A61J 7/02; A61J 7/00

(52) U.S. Cl. CPC A61J 7/02; A61J 2205/40; A61J 2200/70; A61J 7/0076

(57) ABSTRACT

The present invention discloses an apparatus for counting discrete objects, said apparatus comprises of a hopper 1; an incline feeder 2 containing an inlet and an outlet; a single optical zone that allows detection of the discrete objects 10 entering from the feeder outlet; a controller which provides the count of the discrete objects; a screen for displaying the count of the discrete objects; wherein the incline feeder outlet is arranged orthogonally to the optical zone. The present invention discloses a method for counting discrete objects comprising the steps of inputting the discrete objects 10 into the hopper 1; passing the discrete objects through the incline feeder 2 such that they enter into the optical zone; optical zone sensing the entering discrete object 10 and transmitting a signal to the controller; displaying the count on a screen; dispensing the counted discrete objects.

### FIELD OF INVENTION

The present invention relates to an apparatus and a method for counting discrete objects, which is particularly useful for dispensing or packaging a fixed number of pills into vials or bottles. The present invention relates to an apparatus for optically counting discrete objects.

### BACKGROUND

Optical pill counters work by detecting each discrete object that passes its optical sensor. In a typical optical counter, pills that are poured into the top of a chute are detected by an optical sensor as they pass multiple optical zones. The apparatus reads the total pills counted when the last of the pills are through. The optical zone that scan the discrete objects usually comprises of a source side which comprises of an illuminating means and a receiver side which comprises of a sensor that sends a signal to a controller.

Manual feeding of the discrete objects into the pill counter results in a chaotic entry of said objects into the optical zone. Such a method also has the additional disadvantage of resulting in false positives due to shadows of the discrete objects. Thus, in order to obtain an accurate count of discrete objects, most of the manual feed optical counters use at least two or more optical arrays generating two or more projections of the count, with the highest count considered as the final count displayed on the screen.

U.S. Pat. No. 5,768,327 discloses an apparatus for optically counting discrete objects comprising a pair of linear optical sensor arrays arranged along orthogonal sides of the feeding channel and a corresponding pair of illuminating source arranged along the opposite adjacent sides of the feeding channel such that each sensor in each array receives light from the corresponding light source. Each of the sensor arrays sends a count to the controller and the higher of the two conservative counts is accepted as the accurate count and is displayed on a numeric display. The patent further discloses a third and fourth sensor arrays and corresponding light sources located downstream of the first and second arrays. The outputs of each of the sensor arrays are processed separately and the highest conservative count is accepted as the accurate count and is displayed on a numeric display. By design, these optical counters are prone to inaccuracies and errors due to false positives and require two or more sets of optical arrays and accordingly two or more projections of the count of discrete objects from each array for counting.

The present invention overcomes the disadvantages of optical counters that use manual feeding and accurately counts discrete objects with a single projection of the count instead of using several projections. The apparatus according to the invention only requires a single illuminating array and a single sensing array and enables a user to count discrete objects using a novel approach in an accurate and quick manner. The present invention also provides an apparatus for counting discrete objects with different shapes and different materials with good accuracy and speed without the need for multiple count projections from multiple photo arrays.

### SUMMARY

The present invention discloses an apparatus for counting discrete objects, said apparatus comprises of a hopper 1; an incline feeder 2 containing an inlet and an outlet; a single optical zone that allows detection of the discrete objects 10 entering from the feeder outlet; a controller which provides the count of the discrete objects; a screen for displaying the count of the discrete objects; wherein the incline feeder outlet is arranged orthogonally to the optical zone. The present invention discloses a method for counting discrete objects comprising the steps of inputting the discrete objects 10 into the hopper 1; passing the discrete objects through the incline feeder 2 such that they enter into the optical zone; optical zone sensing the entering discrete object 10 and transmitting a signal to the controller; displaying the count on a screen; dispensing the counted discrete objects.

### DESCRIPTION OF THE FIGURES

FIG. 1 shows the apparatus for optically counting discrete objects as embodied by the present invention.

FIG. 2 shows the optical zone that comprises of a single source side and a receiver side, where the receiver side comprises of a lens 7 and an image sensor 8.

FIG. 3 shows the optical zone that comprises of a receiver side with a large optical image sensor 8A.

### DESCRIPTION OF THE PREFERRED EMBODIMENT

The invention is defined with reference to the appended claims and figures. With respect to the claims, the glossary below provides the definitions.

The preferred embodiment of the present invention comprises of a hopper 1, an incline feeder 2, a single optical zone, a controller, a receptacle 11 for collecting the counted objects, and a screen for displaying the count of the discrete objects.

A Hopper 1 according to the invention comprises of a receptacle for delivering discrete objects to the incline feeder 2. The hopper 1 has a cooperating means therewith by which it may be attached to the incline feeder 2. A hopper 1 according to the invention provides an inlet to feed the discrete objects 10 onto the incline feeder. In a preferred embodiment, a user feeds discrete objects that are to be counted into the hopper 1, and the objects move onto the incline feeder 2. The hopper 1 according to the invention may be differently sized with a means to conveniently detach and attach therewith. More specifically, a hopper 1 with a smaller internal width maybe used for processing smaller discrete objects and a hopper with a larger internal width maybe used for processing relatively larger discrete objects. For example, if the user is measuring small tablets, he may attach a hopper with a smaller internal width.

The incline feeder 2 according to the invention has a substantially inclined surface comprising of a chute body having an upper chute portion with an open inlet end, and a lower chute portion with an open discharge end. The upper chute portion has a cooperating means therewith by which it may be attached to the Hopper 1. The lower discharge end is situated orthogonally to the optical zone. The incline feeder 2 further comprises of an optional safety cover 3 to protect the discrete objects from dust and the surrounding atmosphere. In a preferred embodiment of the invention, the discrete objects 10 fed into the hopper 1 enter on to the inclined surface of the feeder 2 through its upper chute portion through the open inlet, move to the lower chute portion, and exit the feeder through the open discharge end, to enter the optical zone. In a preferred embodiment, the incline feeder 2 may be situated in a manner that allows the discrete objects exiting the feeder to enter into the optical zone in a controlled manner. In a preferred embodiment, the incline feeder 2 prevents chaotic entry of the discrete objects into the optical zone. The incline feeder 2 of the present invention facilities dispersing the discrete objects moving into the optical zone and thereby reduces false positives resulting from shadows of the discrete objects. The incline feeder 2 of the invention may have differently shaped discharge ends. For example, the incline feeder may have a lower chute portion that ends as a rounded discharge end B. In an alternate embodiment, the incline feeder 2 may have a lower chute portion that ends as a straight discharge end A. In an embodiment of the invention, the incline angle of the feeder may be customized to control the separation distance between consecutive discrete objects or the rate of objects entering the optical zone to allow for an optimal counting process.

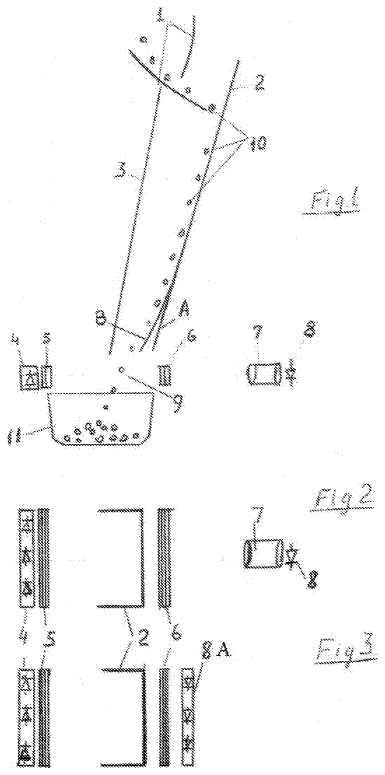

The optical zone according to the invention comprises of at least one source side and at least one receiver side located on opposite sides of each other, such that the light from the source side may be received by the sensor on the receiver side. The optical zone according to the invention is arranged orthogonally to the discharge end of the incline feeder. In a preferred embodiment of the present invention, the optical zone comprises of a single source side and a single receiver side, and is arranged orthogonally to the discharge end of the incline feeder. The source side according to the invention comprises of a linear radiation source 4 that produces visible, ultraviolet or infra-red light radiation. Filters may be added to isolate the desired type of radiation from the light spectrum. Different kinds of filters may be employed towards this end such as filters which decrease the optical noise, polarized light, infra-red light, visible light or variety of transmission bands. In a preferred embodiment, the linear radiation source 4 maybe filtered via filter 5 on the source side and another filter 6 on the receiver side such that they result in isolating a single type of desired radiation beam. The desired radiation beam is selected based on the type of discrete object to be counted. In this embodiment, the filters decreases optical noise, duplicate counting of a discrete object, polarized light, infra-red light, visible light and variety of transmission bands. The optical zone according to the invention is depicted in FIG. 1, 2 or 3.

The receiver side according to the invention comprises of a lens 7, and a miniature image sensor 8. In this embodiment, as shown in FIG. 1 and FIG. 2, lens 7 projects image of the discrete objects to the image sensor 8 and the image sensor has the means to transmit said signal to a controller. In an alternative embodiment, the receiver side comprises of a large optical image sensor 8A. In this embodiment, as shown in FIG. 3, the large image sensor 8A has the same width as that of the feeder outlet and detects the shadows of the discrete objects projected onto it, and transmits the signal to the controller. In a preferred embodiment, a desired radiation beam from the source side 4 is received by the sensor 8, 8A on the receiver side. The discrete objects that enters the path of the beam is detected by the receiver side and a signal is transmitted to the controller.

In a preferred embodiment of the invention a discrete object fed into the hopper 1 moves onto the incline surface of the feeder 2 and enters into the optical zone. The optical zone detects the presence of the object and transmits the signal to the controller. A receptacle 11 or a bowl collects the discrete objects exiting from the optical zone.

The controller according to the invention is a central unit which receives input from the image sensor and has the means to record the number of discrete objects corresponding to said signal from image sensor. In an embodiment of the invention, the controller may be used in combination with a software to record the objects passing the optical zone. The controller further has a means to transmit said count of discrete objects to the display screen. The display screen according to the invention displays the number of discrete objects as recorded by the controller.

The software according the invention may be any of the marketed software programs that recognize, record and/or display the count on the display screen. In an alternate embodiment, the software according to the invention may be uniquely developed for the apparatus of the present invention to serve the specific goals of the users.

In a preferred embodiment, the method of counting discrete objects comprises the steps of: inputting the discrete objects 10 into the hopper; moving the discrete objects through the inclined surface of the feeder 2 such that they enter into the optical zone; detection of the discrete object at the optical zone and transmitting said detection from the image sensor to the controller; displaying the count of discrete objects on a screen and collection of the discrete objects in a receptacle 11, bowl or a dispensing container. A user may thereby dispense a required number of counted objects into a container ready for dispensing.

In an embodiment of the invention, the optical counting apparatus may be enclosed in a housing, which housing comprises means for protecting the apparatus from dust and outside environment.

While the invention has been described above with reference to specific embodiments thereof, it is apparent that many changes, modifications, and variations can be made without departing from the inventive concept disclosed herein, and such description is not intended as limitations on the scope thereof. Accordingly, it is intended to embrace all such changes, modifications, and variations that fall within the spirit and broad scope of the appended claims.

What is claimed is:

1) An apparatus for counting discrete objects, said apparatus comprising:
(a) a hopper 1;
(b) an incline feeder 2 containing an inlet and an outlet;
(c) a single optical zone that allows detection of the discrete objects 10 entering from the feeder outlet; and
(d) a controller which provides the count of the discrete objects;
(e) a screen for displaying the count of the discrete objects;
wherein the outlet of the incline feeder is arranged orthogonally to the optical zone.

2) The apparatus of claim 1, wherein the incline feeder further comprising of a safety cover 3.

3) The apparatus of claim 1, wherein the optical zone comprises of a source side and a receiver side.

4) The apparatus of claim 3, wherein the source side comprises of a linear radiation source 4.

5) The apparatus of claim 4, wherein the linear radiation source 4 may be visible, ultraviolet or infra-red light.

6) The apparatus of claim 4, wherein the receiver side comprises of:
(a) a lens 7; and
(b) an image sensor 8;
wherein the lens projects images of the discrete objects to the image sensor 8,
and wherein the image sensor sends a signal to the controller.

7) The apparatus of claim 5, wherein the linear radiation source maybe filtered on the source side 5 and/or the receiver side 6; wherein such filtration decreases optical noise, duplicate counting of a discrete object, polarized light, infra-red light, visible light and variety of transmission bands.

8) The apparatus of claim 4, wherein the receiver side comprises of a large image sensor 8A, wherein the large image sensor detects the shadows of the discrete objects projected onto it, and sends the signal to the controller.

9) The apparatus of claim 8, wherein the large image sensor 8A has the same width as that of the feeder outlet.

10) The apparatus of claim 6, wherein the controller may be used in combination with a software.

11) The apparatus of claim 10, wherein the controller comprises of a means to record the number of discrete objects and displays the number of discrete objects on a screen.

12) A method of counting discrete objects using the apparatus of claim 1, comprising the steps of:
(i) inputting the discrete objects 10 into the hopper;
(ii) passing the discrete objects through the incline feeder 2 such that they enter into the optical zone;
(iii) optical zone sensing the entering discrete object 10 and transmitting a signal to the controller;
(iv) displaying the count on a screen;
(iv) dispensing the counted discrete objects.

13) The apparatus of claim 12, wherein the discrete objects are tablets, capsules or other small pharmaceutical products.

14) The apparatus of claim 13, wherein the discrete objects are metal parts.

15) The apparatus of claim 14, wherein the width of the incline feeder may be adjusted for accommodating discrete objects with varied a shape or size.

16) The apparatus of claim 1, wherein the incline angle of the incline feeder may be adjusted to control the separation distance between consecutive discrete objects entering the optical zone.

17) The apparatus of claim 1, wherein said apparatus is enclosed within a housing that comprises of means to protect the apparatus from dust and outside environment.
